(19) United States
(12) Patent Application Publication
(10) Pub. No.: US 2011/0010636 A1
(43) Pub. Date: Jan. 13, 2011

(54) SPECIFICATION OF A CHARACTERISTIC OF A VIRTUAL UNIVERSE ESTABLISHMENT

(75) Inventors: Rick A. Hamilton, II, Richmond, VA (US); Brian M. O'Connell, Research Triangle Park, NC (US); Clifford A. Pickover, Yorktown Heights, NY (US); David I. Seidman, Passaic, NJ (US); Keith R. Walker, Austin, TX (US)

Correspondence Address: HOFFMAN WARNICK LLC, 75 STATE ST, 14TH FLOOR, ALBANY, NY, 12207, US

(73) Assignee: International Business Machines Corporation, Armonk, NY (US)

(21) Appl. No.: 12/501,922

(22) Filed: Jul. 13, 2009

(51) Int. Cl. G06F 3/01; G06Q 30/00; G06Q 50/00

(52) U.S. Cl. 715/747; 705/26.7

(57) ABSTRACT

An approach that provides personalized control of a characteristic of a virtual universe establishment is described. In one embodiment, there is a virtual universe establishment characteristics control tool that comprises an establishment characteristic preference component configured to receive from a visiting resident a specified establishment characteristic preference for interacting with the virtual universe establishment. The virtual universe establishment characteristics control tool further comprises an establishment characteristic change component configured to change the establishment characteristic of the virtual universe establishment in accordance with the received establishment characteristic preference.

### FIELD OF THE INVENTION

This invention relates generally to virtual environments and more specifically to providing personalized control of characteristics of a virtual universe establishment.

### BACKGROUND OF THE INVENTION

Virtual universes or virtual worlds are computer-based simulated environments intended for its users or residents to inhabit and interact via avatars, which are personas or representations of the users of the virtual universes and generally take the form of two-dimensional or three-dimensional human or fantastical representations of a person's self. These types of virtual universes are now most common in massively multiplayer online games such as Second Life which is a trademark of Linden Research in the United States, other countries or both. Avatars in these types of virtual universes, which can number well over a million, have a wide range of business and social experiences. These avatars create, manipulate and buy and sell every aspect of their virtual lives. It is common in some of these virtual universes to exchange millions of US dollars on a monthly basis in support of these virtual experiences. As a result, these virtual universes provide a fertile ground for improving upon the experience that a resident via its avatar may have while visiting a virtual universe establishment and contemplating whether to purchase items.

### SUMMARY OF THE INVENTION

In one embodiment, there is a method for providing personalized control of a characteristic of a virtual universe establishment. In this embodiment, the method comprises: receiving a specified establishment characteristic preference from a visiting resident for interacting with the virtual universe establishment; and changing the establishment characteristic of the virtual universe establishment in accordance with the received establishment characteristic preference.

In a second embodiment, there is a computer system providing personalized control of a characteristic of a virtual universe establishment. In this embodiment, the system comprises at least one processing unit and memory operably associated with the at least one processing unit. A virtual universe establishment characteristic control tool is storable in memory and executable by the at least one processing unit. The virtual universe establishment characteristic control tool comprises an establishment characteristic preference component configured to receive from a visiting resident a specified establishment characteristic preference for interacting with the virtual universe establishment. An establishment characteristic change component is configured to change the characteristic of the virtual universe establishment in accordance with the received establishment characteristic.

In a third embodiment, there is a computer-readable medium storing computer instructions, which when executed, enables a computer system to provide personalized control of a characteristic of a virtual universe establishment. In this embodiment, the computer instructions comprise: receiving from a visiting resident a specified establishment characteristic preference for interacting with the virtual universe establishment; and changing the establishment characteristic of the virtual universe establishment in accordance with the received establishment characteristic preference.

In a fourth embodiment, there is a method for deploying a virtual universe establishment characteristics control tool for use in a computer system that facilitates personalized control of a characteristic of a virtual universe establishment. In this embodiment, a computer infrastructure is provided and is operable to: receive from a visiting resident a specified establishment characteristic preference for interacting with the virtual universe establishment; and change the establishment characteristic of the virtual universe establishment in accordance with the received establishment characteristic preference.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of the virtual universe client shown in FIG. 1;

FIG. 3 shows a more detailed view of some of the functionalities provided by the server array shown in FIG. 1;

FIG. 4 shows a virtual universe establishment characteristics tool according to one embodiment of this invention that operates in the environment shown in FIG. 1;

FIG. 5 shows a flow chart describing the general operations performed by the virtual universe establishment characteristics tool shown in FIG. 4; and

FIG. 6 shows a schematic of an exemplary computing environment in which elements of the networking environment shown in FIG. 1 may operate.

### DETAILED DESCRIPTION OF THE INVENTION

Embodiments of this invention are directed to a technique for providing personalized control of characteristics of a virtual universe establishment. As used herein a virtual universe establishment is any established location within a virtual universe where residents or users of the universe can interact and experience a virtual world via their avatars. In the description that follows, a virtual universe establishment is a virtual retail store, however, the scope of this invention is suitable for use in other virtual world establishments where it may be desirable to provide personalized control of the establishment. Other examples of a virtual universe establishment may include streets, thoroughfares, complexes, educational institutions and museums. Personalized controlled of the characteristics of an establishment enables residents of the universe and proprietors of virtual retail stores to control certain characteristics of the establishment. An illustrative but non-exhaustive listing of characteristics that can be personalized include appearance of the establishment such as store architecture, style, decor, location, product selection, product pricing and audio themes. In one particular embodiment, a characteristic preference can be specified manually by a resident or a proprietor of the virtual universe store. In another embodiment, characteristic preferences for a resident can be learned and generated automatically. In still another embodiment, characteristic preferences can be specified through tags that associate to a predetermined preference for interacting with the virtual universe store.

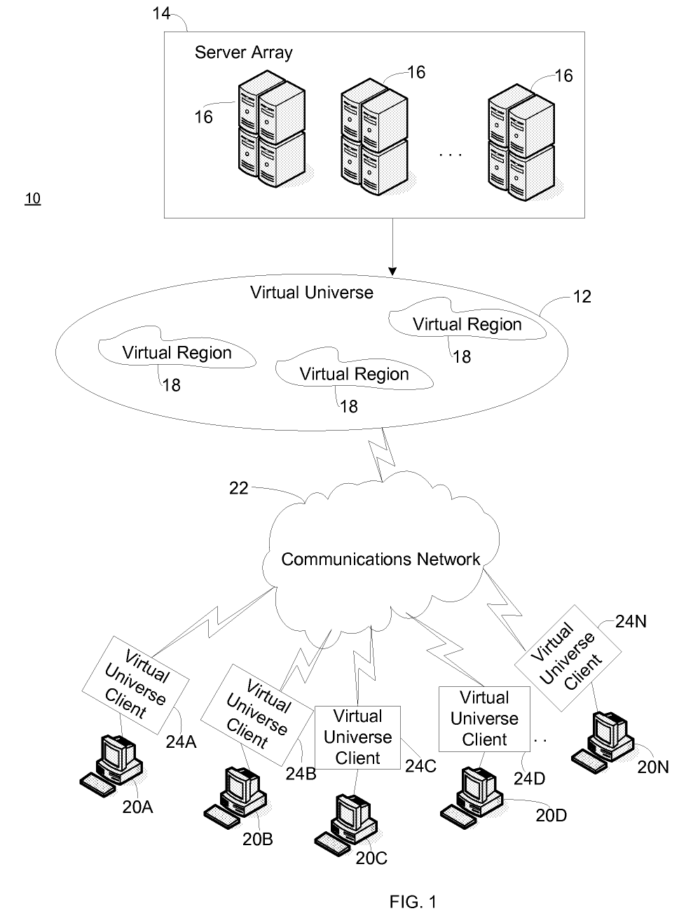

FIG. 1 shows a high-level schematic diagram showing a networking environment 10 for providing a virtual universe 12 according to one embodiment of this invention in which a virtual universe establishment versioning tool can be utilized. As shown in FIG. 1, the networking environment 10 comprises a server array or grid 14 comprising a plurality of servers 16 each responsible for managing a sliver of virtual real estate within the virtual universe 12. A virtual universe provided by a typical massively multiplayer online game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20N (hereinafter referred generally as 20) interact with the virtual universe 12 through a communication network 22 via virtual universe clients 24A-24N (hereinafter referred generally as 24) that resides in the computers, respectively. Below are further details of the virtual universe 12, server array 14, and virtual universe client 24.

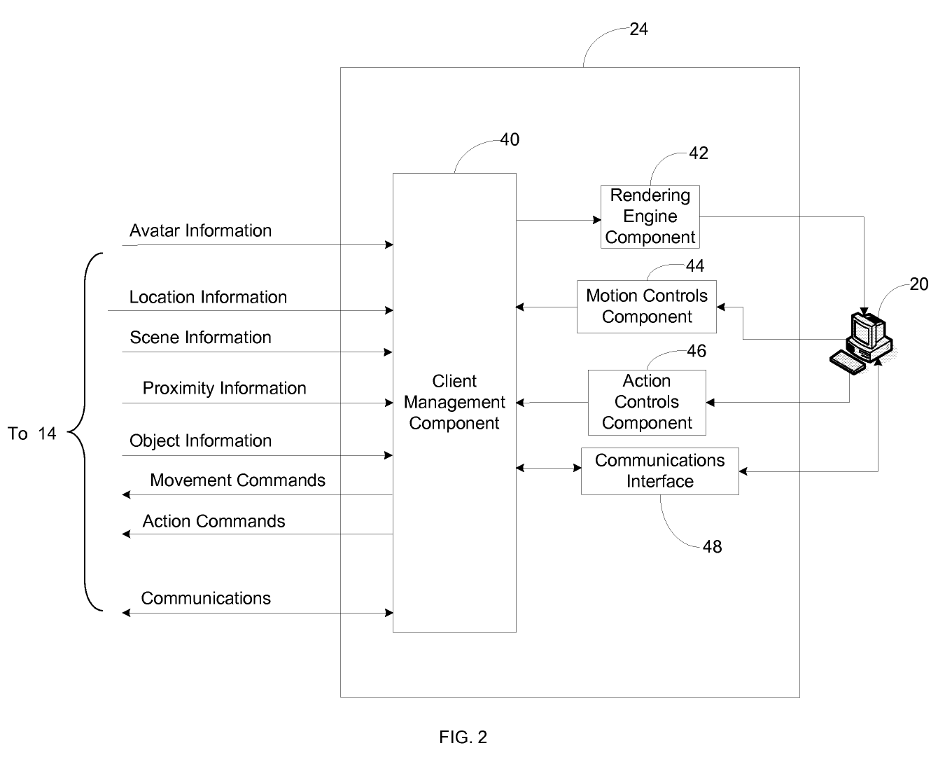

FIG. 2 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc. An action controls component 46 enables the user to perform actions in the virtual universe such as buying items for his or her avatar or even for their real-life selves, building homes, planting gardens, etc. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and electronic mail (e-mail).

FIG. 2 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or land he or she is in) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., invoking, pushing, picking up, etc.). FIG. 2 also shows the movement commands and action commands that are generated by the user are sent to the server array via the client management component 40, as well as the communications that can be sent to the users of other avatars within the virtual universe.

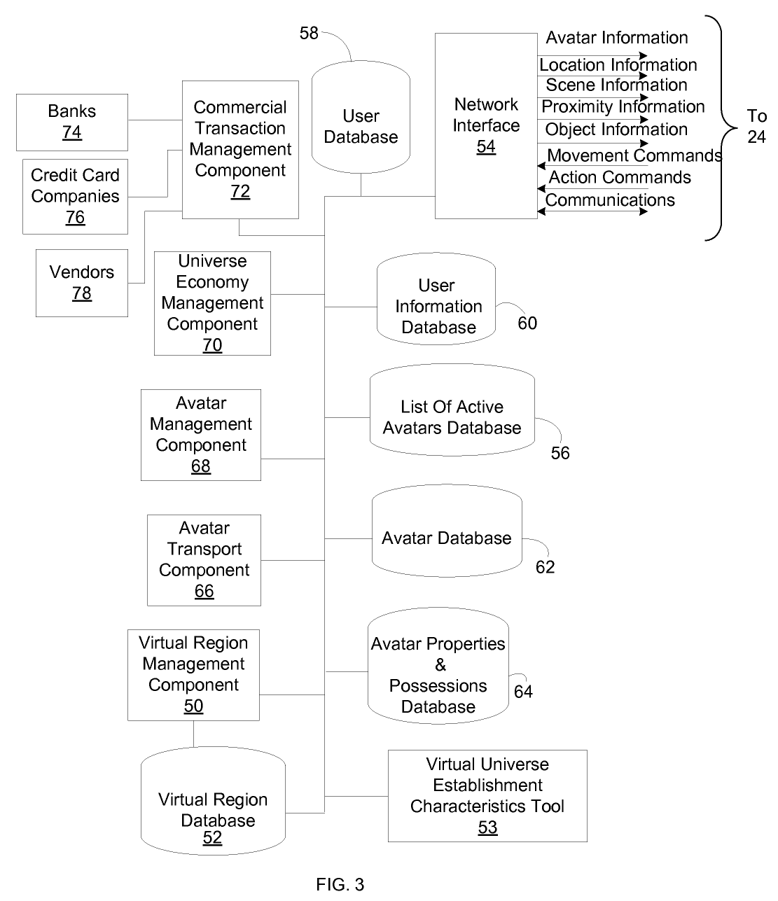

FIG. 3 shows a more detailed view of some of the functionalities provided by the server array 14 shown in FIG. 1. In particular, FIG. 3 shows a virtual region management component 50 that manages a virtual region within the virtual universe. In particular, the virtual region management component 50 manages what happens in a particular region such as the type of landscape in that region, the number of homes, commercial zones, boutiques, streets, parks, restaurants, etc. For example, the virtual region management component 50 would allow the owner of a particular region or establishment within the region to specify requirements for entering or remaining within the region that could potentially affect certain avatar characteristics. In addition, the virtual region management component 50 would allow the owner of a particular region or establishment to provide a textual description that describes the area in more detail so that the avatars can ascertain if there will be a potential effect on their use of specific inventory items within that region. Those skilled in the art will recognize that the virtual region management component 50 can manage many other facets within the virtual region.

A virtual region database 52 stores information on all of the specifics in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular land within the virtual region 18.

A virtual universe establishment characteristics control tool 53 enables residents and virtual universe proprietors to change the characteristics of virtual universe establishments situated throughout the virtual universe 12 to a version that is more suitable for allowing one to enjoy their shopping experience in the virtual universe or make it conducive for attracting potential shoppers to an establishment for shopping. For example, the virtual universe establishment characteristics control tool 53 can enable a user or virtual universe proprietor to personalize items including but not limited to store architecture, style, decor, location, product selection, product pricing and audio themes. The virtual universe establishment characteristics control 53 can make changes to the characteristics of a virtual universe establishment based on a manual selection specified by an avatar or a proprietor, or can make changes automatically based on learned shopping behavior of an avatar, or changes can be specified through tags that associate to a predetermined preference. As an example of one of these embodiments, a resident may be at a virtual mall and may have a desire to have the virtual shops in the mall take on the 1930s era. The virtual universe establishment characteristics control tool 53 would receive this selection and change the characteristics of the mall and its shops to take on the 1930 era. As a result, the décor, style and products of the shops can be from the 1930s and priced accordingly to 1930 prices. Below is a more detailed discussion of the virtual universe establishment characteristics control tool 53 and how it performs the above-mentioned functions.

FIG. 3 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

As shown in FIG. 3, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions.

Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features) while database 64 contains an inventory of items that they own, and these inventory items may be bought, sold, traded, etc., during operation of the virtual universe. Items in a typical inventory may include clothing, virtual pets, vehicles, electronic media (e.g., music files), or other possessions. Those skilled in the art will recognize that this listing of inventory items is illustrative of possible items and is not exhaustive. For example, other inventory items may include graphics files, sound files, animations, electronic documents, video files, avatar accessories, avatar body parts, avatar tools or other objects, avatar gestures, automated avatars, calling cards, landmarks (such as bookmarked locations) or other geographical information, items in a lost and found folder, note cards, photos and photo albums, scripts (e.g. macros to perform actions), textures, deleted items, or any other type of item.

Each inventory item may represent a piece of executable code or other data which may be rendered in some fashion to the user during a session in the virtual universe. Clothing inventory, for example, may be rendered as clothing for the user's avatar while a virtual dog, in another example, may render as an automated avatar that follows the user's avatar within the virtual universe. In other embodiments, inventory items may be represented as non-executable data that may be used by the virtual universe to render the inventory item for the user when needed. The contents of a user's inventory are typically displayed in a hierarchical manner similar to an operating system's display of folders, subfolders, and files within a files system.

As virtual universes become more mainstream within a business setting, it is conceivable that users will want to have public and private inventories for their avatar in order to protect unwanted invasion of confidential and proprietary information. Therefore, in one embodiment, the database 62 may contain public and private inventories in order to account for various business and social encounters that need to be shielded from unauthorized parties.

Those skilled in the art will recognize that databases 58-64 may contain additional information if desired. Although the above information is shown in FIG. 3 as being stored in databases, those skilled in the art will recognize that other means of storing information can be utilized.

An avatar transport component 66 enables users to transport, which as mentioned above, allows avatars to transport through space from one point to another point, instantaneously. As a result, an avatar could for example travel from a business region to an entertainment region to hear a concert. Moving from one point or virtual region to another point could ultimately affect the inventory items that an avatar could use in a particular location. For example, if the avatar was leaving work from the business district with some proprietary information then the transformation tool of this invention could transform the proprietary information to a newspaper. In this example, well-known encryption/decryption techniques can be used in the transformation of documentation.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to pay for a service that provides this automatic inventory item transformation. In this case, the avatar would make the purchase of this service using the virtual universe currency. In some instances, the user (i.e., the resident) may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78.

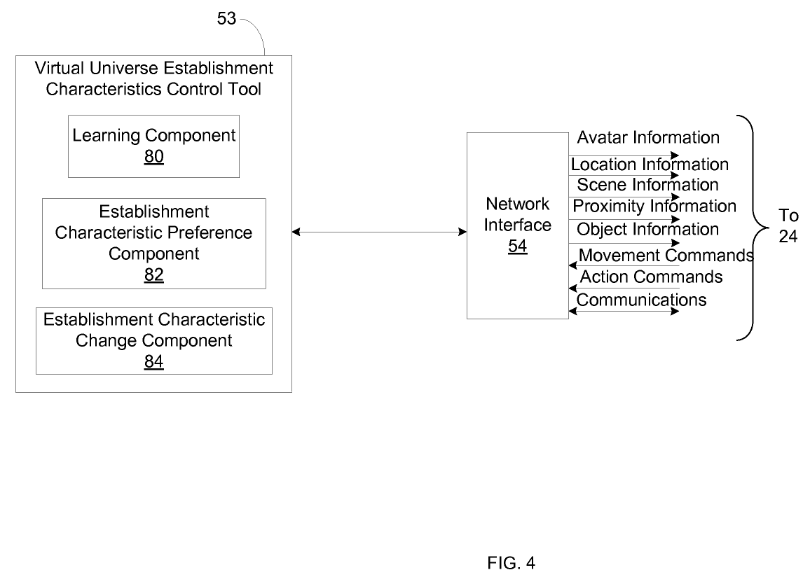

FIG. 4 shows a more detailed view of the virtual universe establishment characteristics control tool 53. In FIG. 4, the virtual universe establishment characteristics control tool 53 in general resides on the same computer system as the server 14 and communicates directly to the virtual universe and its residents via the virtual universe client 24. In other embodiments, the virtual universe establishment characteristics control tool 53 might reside on the same computers as the virtual universe client 24, or reside on separate computers in direct communication with the virtual universe servers 16 and virtual universe clients 24.

As mentioned above, the virtual universe establishment characteristics control tool 53 is configured to provide residents and virtual universe proprietors with several approaches that generate a personalized look and feel for a virtual universe establishment based on desired preferences or preferences believed to be suitable for the residents and proprietors. FIG. 4 shows that the virtual universe establishment characteristics control tool 53 comprises a learning component 80 that is configured to learn preferences for both residents and virtual universe establishment proprietors. In one embodiment, the learning component 80 is configured to observe browsing behavior of an avatar while in the virtual universe. For example, a resident may prefer certain types of malls, futuristic or old-fashioned decor, which can be learned by observing patterns of visits in the virtual universe. Note that a resident's past visits to other virtual universe stores may be logged or recorded by the virtual universe server 14. In another example, in the past a resident may have specified a preference for 1950s décor so a tag is associated with that avatar that indicates this specification in a standard format (i.e., “<1950s look>”). Other examples of tags that express specified preferences might be “<75% plant foliage decoration in the store>” or “<Christmas music>”. In addition to observing past behavior, the learning component 80 uses well-known pattern recognition techniques to ascertain a candidate set of establishment characteristic preferences from the browsing behavior that are believed personalized to the tastes of the avatar. The learning component 80 automatically selects a preference from the candidate set that is specified for the virtual universe establishment (e.g., a retail store) that the avatar is currently in or within proximity thereto or will teleport to.

In addition to automatically generating establishment characteristic preferences, the virtual universe establishment characteristics control tool 53 is configured to enable residents and virtual universe proprietors with an option to manually select their own preferences. As shown in FIG. 4, the virtual universe establishment characteristics control tool 53 comprises an establishment characteristic preference component 82 that is configured to receive an establishment characteristic preference specified by residents or virtual universe proprietors through the virtual universe client 24. For example, residents and virtual universe proprietors can personalize items including but not limited to store architecture, style, décor, location, product selection, product pricing and audio themes. These options can be made available to the residents (e.g., via a graphical user interface) as they enter a virtual universe store or come within vicinity of the store. In another embodiment, residents may only have the option to select establishment characteristics that the proprietors wants to make available to the residents. In one embodiment, a particular virtual universe store may have five versions of its store embodied in the virtual universe. One version may be modern, while another contains the characteristics of the 1950s. The desired characteristics from these choices may be selected by a virtual universe customer. In another embodiment, the avatar can accept a default version of the retail store and not make any changes. Also, it is possible that the avatar can select a random set of establishment characteristic preferences to customize or specify some or all of the customizable characteristics for the store. In one embodiment, a virtual universe proprietor can use the establishment characteristic preference component 82 to manually set a version for an establishment based on changes made by other users. For example, the default version of a virtual universe establishment for future visits can be decided by which version the majority of the users choose over a period of time. It is also possible that user consensus can determine the items offered, the size of the store, etc.

The establishment characteristic preference component 82 can also generate preferences based on tags that have been pre-specified by residents and virtual universe proprietors. For example, as an avatar approaches a particular establishment or is about to teleport to the establishment, the virtual universe establishment characteristics control tool 53 via the establishment characteristic preference component 82 can recognize the avatar at the location and pull the tags out from the avatars' inventory (database 64) that have been pre-specified so that the characteristics of the establishment can be changed accordingly.

In another embodiment, the tags can be stored in a designated policy table as opposed to an avatar's inventory. For example, an avatar may have specified a “taste” in the policy table, such as a taste to have stores with ambient music playing. The avatar may have a “taste” to see all items of a particular type colored red so that the avatar may locate the items easily or remember where they are located. Alternatively, the store may supply a graphical user interface to enable avatars to select various preferences. Physically challenged users (such as visually impaired or deaf people) may specify their physical challenge, and stores may change their visual or audio themes to accommodate. For example, fonts on products may be larger, brighter, or in higher contrast and—audio messages may be replaced by text messages. For example, a user who doesn't like to be around other people may specify a preference to be alone, and other avatars will not be rendered or a physically challenged person can change access to establishments and adjust audio and text displays based on hearing and visual impairments. Also displays in establishments can be changed to display child-friendly content.

As shown in FIG. 4, the virtual universe establishment characteristics control tool 53 comprises an establishment characteristic change component 84 configured to change the characteristic of the virtual universe establishment in accordance with the specified characteristic preference. In one embodiment, changing the characteristic of the virtual universe establishment (e.g., the virtual store) comprises generating a representation of the establishment in accordance with the changed characteristic. A rendering of the representation is provided to avatar(s) via the virtual universe client 24. For example, depending on the establishment characteristic preferences, the establishment characteristic change component 84 can change the architecture of a retail store from modern to classical, the layout motif to have for example wooden shelves versus chrome container racks, the style to be art nouveau, the product selection to take on the selection available from a certain time period (e.g., 1820s) with accompanying pricing and currency valuation conversion. Note that sometimes a user preference might not be able to be rendered due to limitations in choices that the proprietor has available.

In another embodiment, the establishment characteristic change component 84 is configured to generate representations that are independent of other representations of the virtual universe establishment that are viewed by other avatars in the virtual universe. For example, there can be more than one avatar in the virtual universe retail store with each seeing a different representation of the store. For instance, one avatar can see a futuristic retail shop with futuristic products and décor, while another avatar can see the store as one might find in the 1700s. In this example, the avatars could still interact as normal with each other but they just will not see the store in the same manner.

In another embodiment of this invention, the virtual universe establishment characteristic control tool 53 is used as a service to charge fees for facilitating personalized controlled versioning of a virtual universe establishment. In this embodiment, the provider of the virtual universe or a third party service provider could offer this personalized control of establishment characteristics as a service by performing the functionalities described herein on a subscription and/or fee basis. In this case, the provider of the virtual universe or the third party service provider can create, deploy, maintain, support, etc., the virtual universe characteristic control tool 53 that performs the processes described in the invention. In return, the virtual universe or the third party service provider can receive payment from the virtual universe residents via the universe economy management component 70 and the commercial transaction management component 72.

In still another embodiment, the methodologies disclosed herein can be used within a computer system to facilitate personalized control of characteristics of a virtual universe establishment. In this case, the virtual universe establishment characteristics control tool 53 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

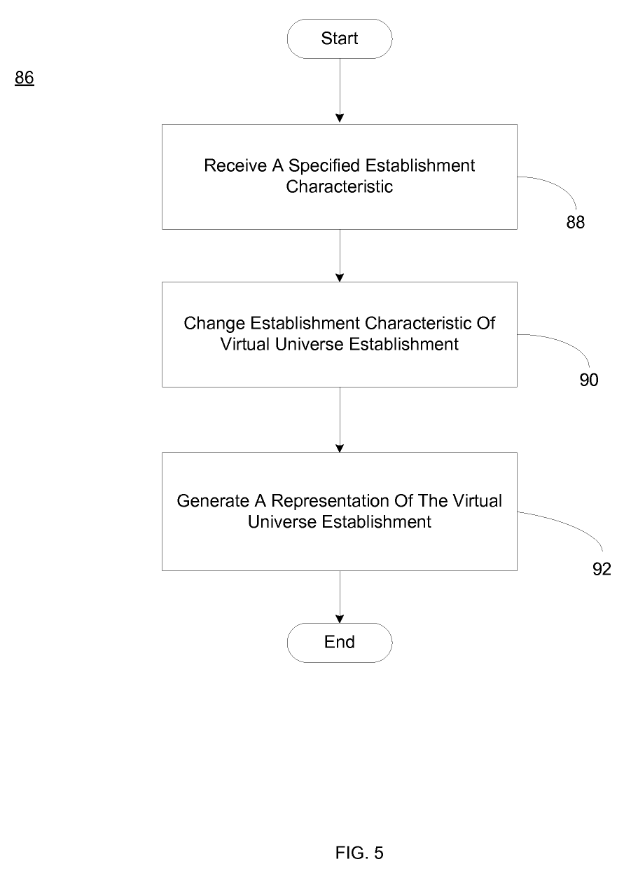

FIG. 5 shows a flow chart describing the general operations performed by the virtual universe establishment characteristics tool shown in FIG. 4. In FIG. 5, flow chart 86 begins at 88 by receiving a specified establishment characteristic preference from a visiting resident for interacting with the virtual universe establishment. In one embodiment, the receiving of the specified establishment characteristic preference comprises receiving a specification made manually by the resident. In another embodiment, the receiving of the specified establishment characteristic preference comprises observing browsing behavior of the resident while in the virtual universe, ascertaining a candidate set of establishment characteristic preferences for the resident from the browsing behavior and automatically selecting an establishment characteristic preference from the candidate set that is specified for the virtual universe establishment. In a third embodiment, the receiving of the specified establishment characteristic preference comprises receiving a tag associated with the resident that specifies a predetermined preference for interacting with the virtual universe establishment. In still another embodiment, the receiving of the specified establishment characteristic preference comprises receiving a selection made by the resident from a plurality of predetermined establishment characteristic preferences specified by a proprietor of the virtual universe establishment.

The specified establishment characteristic preference embodies a plurality of characteristics that enhance an interaction by the resident with the virtual universe establishment. In one embodiment, the plurality of characteristics comprise appearance of the virtual universe establishment, location of the virtual universe establishment, product selection associated with the virtual universe establishment, product pricing associated with the virtual universe establishment, and audio themes associated with the virtual universe establishment.

Referring back to FIG. 5, flow chart 86 continues by changing the establishment characteristic of the virtual universe establishment in accordance with the received establishment characteristic preference at 90. After changing the establishment characteristic, next at 92, a representation of the virtual universe establishment is generated that is in accordance with the changed establishment characteristic for rendering to the resident. In one embodiment, the generated representation is independent of other representations of the virtual universe establishment that are viewed by other residents in the virtual universe.

The foregoing flow chart shows some of the functions associated with the general operations performed by the virtual universe establishment characteristics tool. In this regard, each block represents a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe the processing functions may be added.

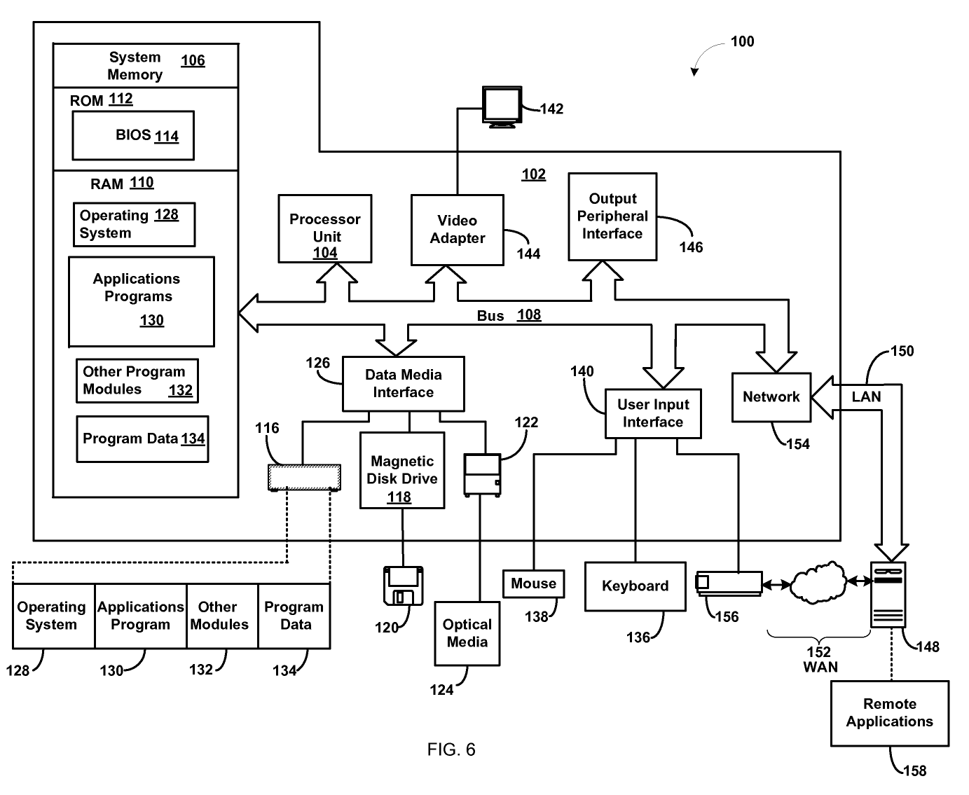

FIG. 6 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 6.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 6, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 6, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 6 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 1 18 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including the server array 14, the virtual universe client 24 and the virtual universe establishment characteristics control tool 53. In one embodiment, the one or more application programs 130 include components of the virtual universe establishment characteristics control tool 53 such as the learning component 80, establishment characteristic preference component 82, and establishment characteristic change component 84.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 6 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 6 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for providing personalized control of a characteristic of a virtual universe establishment. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for providing personalized control of a characteristic of a virtual universe establishment, comprising:
receiving a specified establishment characteristic preference from a visiting resident for interacting with the virtual universe establishment; and
changing the establishment characteristic of the virtual universe establishment in accordance with the received establishment characteristic preference.

2. The method according to claim 1, wherein the receiving of the specified establishment characteristic preference comprises receiving a specification made manually by the resident.

3. The method according to claim 1, wherein the receiving of the specified establishment characteristic preference comprises observing browsing behavior of the resident while in the virtual universe, ascertaining a candidate set of establishment characteristic preferences for the resident from the browsing behavior and automatically selecting an establishment characteristic preference from the candidate set that is specified for the virtual universe establishment.

4. The method according to claim 1, wherein the receiving of the specified establishment characteristic preference comprises receiving a tag associated with the resident that specifies a predetermined preference for interacting with the virtual universe establishment.

5. The method according to claim 1, wherein the receiving of the specified establishment characteristic preference comprises receiving a selection made by the resident from a plurality of predetermined establishment characteristic preferences specified by a proprietor of the virtual universe establishment.

6. The method according to claim 1, wherein the specified establishment characteristic preference embodies a plurality of characteristics that enhance an interaction by the resident with the virtual universe establishment.

7. The method according to claim 6, wherein the plurality of characteristics comprise appearance of the virtual universe establishment, location of the virtual universe establishment, product selection associated with the virtual universe establishment, product pricing associated with the virtual universe establishment, and audio themes associated with the virtual universe establishment.

8. The method according to claim 1, further comprising generating a representation of the virtual universe establishment in accordance with the changed establishment characteristic for rendering to the resident.

9. The method according to claim 8, wherein the generated representation is independent of other representations of the virtual universe establishment that are viewed by other residents in the virtual universe.

10. A computer system for providing personalized control of a characteristic of a virtual universe establishment, comprising:
at least one processing unit;
memory operably associated with the at least one processing unit; and
a virtual universe establishment characteristic control tool storable in memory and executable by the at least one processing unit, the tool comprising:
an establishment characteristic preference component configured to receive from a visiting resident a specified establishment characteristic preference for interacting with the virtual universe establishment; and
an establishment characteristic change component configured to change the characteristic of the virtual universe establishment in accordance with the received establishment characteristic.

11. The system according to claim 10, wherein the establishment characteristic preference component is configured to receive a specification made manually by the resident.

12. The system according to claim 10, wherein the establishment characteristic preference component is configured to receive a tag associated with the resident that specifies a predetermined preference for interacting with the virtual universe establishment.

13. The system according to claim 10, wherein the establishment characteristic preference component is configured to receive a selection made by the resident from a plurality of predetermined characteristic preferences specified by a proprietor of the virtual universe establishment.

14. The system according to claim 10, further comprising a learning component configured to observe browsing behavior of the resident while in the virtual universe, ascertain a candidate set of establishment characteristic preferences for the resident from the browsing behavior and automatically select an establishment characteristic preference from the candidate set that is specified for the virtual universe establishment, wherein the learning component is configured to provide the selected establishment characteristic preference to the establishment characteristic preference component.

15. The system according to claim 10, wherein the establishment characteristic change component is configured to generate a representation of the virtual universe establishment in accordance with the changed establishment characteristic for rendering to the resident.

16. A computer-readable medium storing computer instructions, which when executed, enables a computer system to provide personalized control of a characteristic of a virtual universe establishment, the computer instructions comprising:
receiving from a visiting resident a specified establishment characteristic preference for interacting with the virtual universe establishment; and
changing the establishment characteristic of the virtual universe establishment in accordance with the received establishment characteristic preference.

17. The computer-readable medium according to claim 16, wherein the receiving of the specified establishment characteristic preference comprises instructions for receiving a specification made manually by the resident.

18. The computer-readable medium according to claim 16, wherein the receiving of the specified establishment characteristic preference comprises instructions for observing browsing behavior of the resident while in the virtual universe, ascertaining a candidate set of establishment characteristic preferences for the avatar from the browsing behavior and automatically selecting an establishment characteristic preference from the candidate set that is specified for the virtual universe establishment.

19. The computer-readable medium according to claim 16, wherein the receiving of the specified establishment characteristic preference comprises instructions for receiving a tag associated with the resident that specifies a predetermined preference for interacting with the virtual universe establishment.

20. The computer-readable medium according to claim 16, wherein the receiving of the specified establishment characteristic preference comprises instructions for receiving a selection made by the resident from a plurality of predetermined establishment characteristic preferences specified by a proprietor of the virtual universe establishment.

21. The computer-readable medium according to claim 16, wherein the specified establishment characteristic preference embodies a plurality of characteristics that enhance an interaction by the resident with the virtual universe establishment, wherein the plurality of characteristics comprise appearance of the virtual universe establishment, location of the virtual universe establishment, product selection associated with the virtual universe establishment, product pricing associated with the virtual universe establishment, and audio themes associated with the virtual universe establishment.

22. The computer-readable medium according to claim 16, further comprising instructions for generating a representation of the virtual universe establishment in accordance with the changed establishment characteristic for rendering to the resident.

23. The computer-readable medium according to claim 22, wherein the generated representation is independent of other representations of the virtual universe establishment that are viewed by other residents in the virtual universe.

24. The computer-readable medium according to claim 16, further comprising instructions for charging a versioning fee for changing the establishment characteristic of the virtual universe establishment.

25. A method for deploying a virtual universe establishment characteristics control tool for use in a computer system that facilitates personalized control of a characteristic of a virtual universe establishment, comprising:
providing a computer infrastructure operable to:
receive from a visiting resident a specified establishment characteristic preference for interacting with the virtual universe establishment; and
change the establishment characteristic of the virtual universe establishment in accordance with the received establishment characteristic preference.
